(19) United States
(12) Patent Application Publication
(10) Pub. No.: US 2003/0018577 A1
(43) Pub. Date: Jan. 23, 2003

(54) Multi-electronic money settlement-of-accounts vicarious execution system

(76) Inventors: Shinichiro Fukushima, Yokohama (JP); Shigeyuki Ito, Zushi (JP); Yutaka Takami, Yokohama (JP); Kenji Matsumoto, Yokohama (JP); Yoshiisa Inoue, Yokohama (JP)

Correspondence Address: MCDERMOTT WILL & EMERY, 600 13TH STREET, N.W., WASHINGTON, DC, 20005-3096, US

(21) Appl. No.: 10/140,433

(22) Filed: May 8, 2002

(30) Foreign Application Priority Data
May 10, 2001 (JP) 2001-139444

(51) Int. Cl. G06F 17/60

(52) U.S. Cl. 705/39

(57) ABSTRACT

A multi-electronic money settlement-of-account vicarious execution system includes a store information storage section. The storage section includes a store information database for storing information of a store-specified money kind specified by the store as a kind of money to be received by the store and information of a store-specified money remittance destination specified by the store as a remittance destination of money. The system further includes an electronic money conversion and remittance section for converting electronic money received from a store user to money of the store-specified money kind in accordance with the information of the store-specified money kind, and remitting money resultant from the conversion to the store-specified money remittance destination in accordance with the information of the store-specified money remittance destination. The store information database stores information of point kinds to be provided for the user.

### BACKGROUND OF THE INVENTION

The present invention relates to a multi-electronic money settlement-of-account vicarious execution system.

As a multi-electronic money settlement-of-account vicarious execution system, there is, for example, one described in JP-A-2000-215258. According to JP-A-2000-215258, “an object of this invention is to provide an integrated electronic money system for improving the convenience and fluidity of electronic money. In an account database 2A of an electronic money service center 7, there is stored information of user accounts including cash accounts of respective users and a plurality of kinds of electronic money accounts, and pool accounts having a configuration similar to that of user accounts. If, for example, the electronic money service center 7 has received an electronic money settlement-of-account vicarious execution service request, then a service processing section 72 orders an account data administration section 73 to convert a fund corresponding to a settlement-of-account money amount of a cash account of a user P7 to predetermined electronic money. The account data administration section 73 moves a fund corresponding to a settlement-of-account money amount from the cash account of the user P7 to a cash account in the pool account, and delivers electronic money corresponding to the settlement-of-account money amount from a predetermined electronic money account to a service processing section 72. The service processing section 72 pays electronic money corresponding to the settlement-of-account money amount to a payee.”

### SUMMARY OF THE INVENTION

In recent years, at real stores and virtual stores using the Internet or the like, settlement-of-account using electronic money instead of cash has begun to be conducted. Although electronic money has high security, it is simple to handle. Therefore, electronic money is considered to be used as settlement-of-account means instead of cash hereafter.

Whereas there is typically one kind in cash, however, there are a plurality of kinds in electronic money. In many cases, a processing procedure of paying-in, payment, and movement is stipulated individually for each kind of electronic money. Therefore, the processing must be advanced according to a procedure satisfying the stipulation. Accordingly, a store desired to be able to use all kinds of electronic money needs to conclude a contract with an electronic money service provider of each kind with respect to all kinds of electronic money and prepare a plurality of devices. This is not realistic because the labor for the procedure and the money burden increase in proportion to the number of kinds of electronic money made usable. On the other hand, for small-sized stores, it is more favorable in many cases to finally receive one kind of electronic money or cash. For the reasons heretofore described, only specific electronic money can be used at some stores in many cases. In this case, the user must prepare a different electronic money according to the store that the user desires to use. It cannot be denied that this trouble prevents the spread.

Furthermore, in the method of JP-A-2000-215258, a store user cannot execute the settlement-of-account unless the store user opens a user account at the center. In addition, even if the store user has established a user account, the store user cannot execute the settlement-of-account unless the store user supplements the account with cash or electronic money. In other words, the settlement-of-account cannot be executed directly with cash or electronic money the user has at hand, but the user needs to pay to the account temporarily and then order settlement-of-account. It is troublesome. Furthermore, in the method of JP-A-2000-215258, settlement-of-account is executed by movement of account information. Therefore, the method is intended for only host type electronic money (electronic money of a kind in which electronic money is stored in a host account), and the method is not intended for ICC type electronic money (electronic money of a kind in which electronic money is stored in an IC card of the user). The ICC type electronic money need not be passed through the host account at the time of settling, but it is moved directly from an IC card of a payer to an IC card of a payee.

In the method of JP-A-2000-215258, therefore, many store users who have not opened accounts with the center, especially store users having ICC type electronic money are missed. In addition, the method is troublesome even for users who have opened accounts because settlement-of-account cannot be executed only after money is temporarily payed into the account.

An object of the present invention is to make it possible for each store user to use electronic money for settlement-of-account at the store without being conscious of the kind of the electronic money that the user has, and opening an account with a center, and with ease.

A multi-electronic money settlement-of-account vicarious execution system according to the present invention includes a store information storage section. The store information storage section includes a store information database for storing information of a store-specified money kind specified by the store as a kind of money to be received by the store and information of a store-specified remittance destination specified by the store as a remittance destination of money. The system further includes an electronic money conversion and remittance section for converting electronic money received from a store user to money of the store-specified money kind in accordance with the information of the store-specified money kind, and then remitting money resultant from the conversion to the store-specified remittance destination in accordance with the information of the store-specified remittance destination.

In the case where electronic money used by the store user for payment is ICC type electronic money, the multi-electronic money settlement-of-account vicarious execution system according to the present invention includes an IC card that handles electronic money of the same kind as electronic money to be used by a store user for payment. As much electronic money as a payment amount is moved from an IC card of the user to the IC card of the multi-electronic money settlement-of-account vicarious execution system.

In the case where electronic money of a store-specified money kind is ICC type electronic money, the multi-electronic money settlement-of-account vicarious execution system according to the present invention includes an IC card that handles electronic money of the store-specified money kind. As much electronic money as a payment amount is moved from the IC card of the multi-electronic money settlement-of-account vicarious execution system to an IC card of a payment destination. In the case where electronic money used by the store user for payment is host type electronic money, the multi-electronic money settlement-of-account vicarious execution system according to the present invention has an account of electronic money of the same kind as electronic money to be used by the store user for payment, in a financial organ that handles electronic money of that kind. As much electronic money as a payment amount is moved from an account of the user to the account of the multi-electronic money settlement-of-account vicarious execution system.

In the case where electronic money used by the store user for payment is host type electronic money, the multi-electronic money settlement-of-account vicarious execution system according to the present invention has an account of electronic money of the store-specified money kind in a financial organ that handles electronic money of that kind. As much electronic money as a payment amount is moved from the account of the multi-electronic money settlement-of-account vicarious execution system to an account of a payment destination.

In addition, the store information database includes information of point kinds to be provided for the user. And the system further includes a point processing section for providing the user with points of a kind indicated by the information of the point kinds.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing a general configuration of a multi-electronic money settlement-of-account vicarious execution system, according to an embodiment of the present invention;

FIG. 2 is a diagram showing a store information database, according to an embodiment of the present invention;

FIG. 3 is a diagram showing a money processing module, according to an embodiment of the present invention;

FIG. 4 is a diagram showing an electronic money conversion rate definition table, according to an embodiment of the present invention;

FIG. 5 is a diagram showing a processing flow of a multi-electronic money settlement-of-account vicarious execution system, according to an embodiment of the present invention;

FIG. 6 is a diagram showing a multi-electronic money settlement-of-account vicarious execution system with point processing added, according to an embodiment of the present invention;

FIG. 7 is a diagram showing a store information database with point processing added, according to an embodiment of the present invention;

FIG. 8 is a diagram showing a point kind and balance data, according to an embodiment of the present invention;

FIG. 9 is a diagram showing a point provision rate definition table, according to an embodiment of the present invention;

FIG. 10 is a diagram showing a processing flow of a multi-electronic money settlement-of-account vicarious execution system with point processing added, according to an embodiment of the present invention;

FIG. 11 is a diagram showing a payment amount confirmation picture according to an embodiment of the present invention;

FIG. 12 is a diagram showing a payment method selection picture, according to an embodiment of the present invention;

FIG. 13 is a diagram showing a payment method selection picture, according to an embodiment of the present invention;

FIG. 14 is a diagram showing a payment method selection picture, according to an embodiment of the present invention;

FIG. 15 is a diagram showing a MIX payment method selection picture, according to an embodiment of the present invention; and

FIG. 16 is a diagram showing an electronic money exchange picture, according to an embodiment of the present invention.

### DESCRIPTION OF THE EMBODIMENTS

Hereafter, embodiments of the present invention will be described by referring to the drawing.

First, an outline of an embodiment will now be described briefly. Each store need not conclude contracts with a plurality of electronic money service providers, but each store concludes a contract with only a multi-electronic money settlement-of-account vicarious execution system provider. As a matter of course, the multi-electronic money settlement-of-account vicarious execution system provider is supposed to have already concluded a contract with each of electronic money service providers. And each store is supposed to be able to use a multi-electronic money settlement-of-account vicarious execution system provided by the multi-electronic money settlement-of-account vicarious execution system provider owing to the contract. This system receives electronic money used by each store user for payment, and converts the electronic money to money (cash or electronic money) of a store-specified money kind, which is a kind specified by the store for reception. And the system remits the converted money to a store-specified remittance destination, which is a remittance destination specified by each store. The store-specified remittance destination is a cash account or an electronic money account specified by each store or an electronic money purse included in an IC card possessed by each store. As a result, it becomes possible for each store that has concluded a contract to provide store users with multi-electronic money settlement-of-accounts at low cost without requiring introduction of a plurality of devices and procedure labor. Furthermore, it becomes possible for each store user to use electronic money in settlement-of-accounts at the store without being conscious of the kind of the electronic money that the store user has. Hereafter, a configuration and operation of this system will be described in detail.

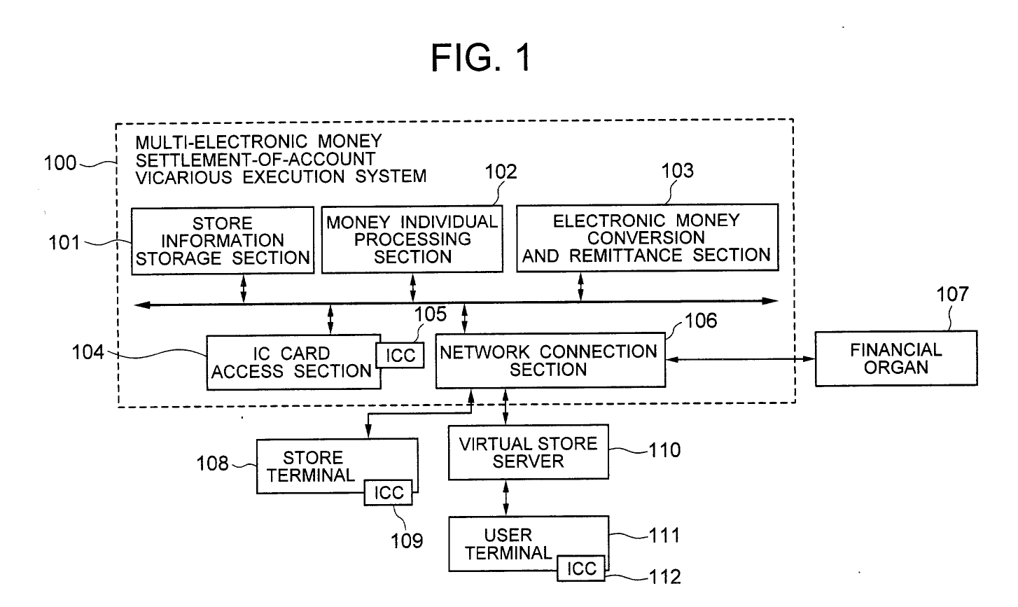

FIG. 1 is a diagram showing a general configuration of a multi-electronic money settlement-of-account vicarious execution system 100 according to the present embodiment. A store information storage section 101 includes a store information database that stores a kind and a remittance destination of electronic money to be remitted to a real or virtual store that is under contract with the multi-electronic money settlement-of-account vicarious execution system provider. A money individual processing section 102 stores a processing module, which stipulates a procedure of processing such as money paying-in, payment and movement corresponding to each money. An electronic money conversion and remittance section 103 converts electronic money used by a store user to a money kind specified for each store, and remits resultant money to an account or to an IC card specified for each store. The money conversion is executed through a financial organ, or between the electronic money and electronic money in an IC card included in the system 100, or by means of cooperation of them (which will be described later in detail). An IC card access section 104 accesses electronic money in an ICC 105 included in the system 100, and conducts paying-in and payment. The ICC 105 saves electronic money of such a type as to be saved in an IC card. A network connection section 106 is connected to each financial organ 107 or a store device through a network. The store device is a store terminal 108 included in a real store or a virtual store server 110. The store terminal 108 can use an ICC 109 possessed by the store. The virtual store 110 is further connected to a user terminal 111. The user terminal 111 can use an ICC 112 of the user.

If it is not necessary to handle electronic money of such a type as to be stored in an IC card, the IC card access section 104 and the ICC 105 are not needed. As the financial organ 107, there are a plurality of organs that handle respective kinds of electronic money and cash.

Operation of the multi-electronic money settlement-of-account vicarious execution system 100 will now be described.

First, a user attempts to purchase a commodity at a real or a virtual store, and attempts to pay electronic money at that time. In the case of a real store, the ICC 109 of the user is inserted in the store terminal 108. If radio connection between the store terminal 108 and the user's ICC 109 is possible in this case, then radio connection is conducted (this holds true in the ensuing description as well). Information of a store ID, an amount paid, and a kind of electronic money is transmitted to the multi-electronic money settlement-of-account vicarious execution system 100 via the network. In the case of a virtual store, the user inserts the ICC 112 into the user terminal 111, and information of an amount paid and a kind of electronic money is transmitted to the virtual store server 110. The virtual store server 110 transmits the received information of the amount paid and the kind of electronic money and information of the store ID to the multi-electronic money settlement-of-account vicarious execution system 100 via the network.

For example, in the case of electronic money of ICC storage type, the user moves electronic money in the IC card that the user has to the ICC 105 in the multi-electronic money settlement-of-account vicarious execution system 100 through a store device and the network connection section. On the other hand, in the case of host type electronic money, the user may move information of electronic money of the user saved in an account opened in a financial organ (host) that is handling host type electronic money by the user to an account opened in a financial organ that is handling host type electronic money by the multi-electronic money settlement-of-account vicarious execution system 100.

Information other than the above described information may be included in information exchanged between the store terminal 108 and the multi-electronic money settlement-of-account vicarious execution system 100, between the user terminal 111 and the virtual store server 110, and between the virtual store server 110 and the multi-electronic money settlement-of-account vicarious execution system 100.

In the multi-electronic money settlement-of-account vicarious execution system 100, information of the store ID, the amount paid and the kind of electronic money is received by the network connection section 106. The information of the store ID is input to the store information storage section 101. The store information storage section 101 refers to the store information database, and retrieves information concerning the kind of electronic money to be remitted to a contract store and remittance destination on the basis of information of the store ID.

Information concerning the kind of electronic money used by the user for payment (kind of conversion source money) and information concerning the kind of electronic money to be remitted to a contract store (kind resulting from conversion) are input to the electronic money conversion and remittance section 103. The electronic money conversion and remittance section 103 converts the kind of conversion source money to the kind of conversion destination. This conversion is executed through the financial organ 107, or between the electronic money and electronic money in the ICC 105 included in the system 100, or by means of cooperation of them. In more detail, the following operation is conducted.

For example, if the store-specified money kind is electronic money of ICC storage type and the store-specified remittance destination is an ICC possessed by a contract store, then electronic money stored in the ICC 105 included in the multi-electronic money settlement-of-account vicarious execution system 100 is moved to the ICC possessed by the contract store. Or if the store-specified remittance destination is an account opened in a financial organ that is handling ICC storage type electronic money by the contract store, then electronic money stored in the ICC 105 included in the multi-electronic money settlement-of-account vicarious execution system 100 is moved to that account.

On the other hand, if the store-specified money kind is electronic money of host type, then information concerning an account opened in a financial organ that is handling host type electronic money by the multi-electronic money settlement-of-account vicarious execution system is moved to an account opened in a financial organ that is handling host type electronic money by the contract store. If the store-specified money kind is cash, then information concerning an account opened in a financial organ that is handling cash by the multi-electronic money settlement-of-account vicarious execution system is moved to an account opened in a financial organ that is handling cash by the contract store.

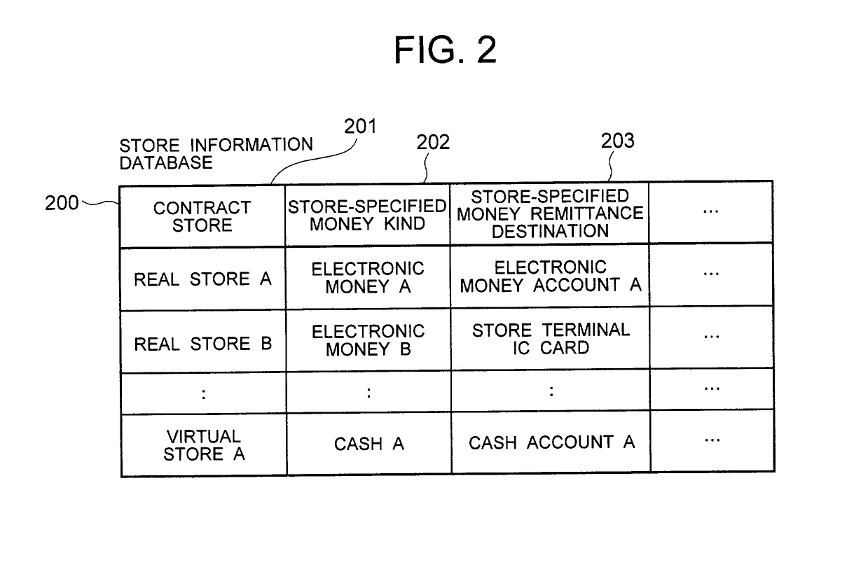

FIG. 2 shows a configuration example of a store information database 200 stored in the store information storage section 101. As items, a contract store 201 that is under contract with the multi-electronic money settlement-of-account vicarious execution system, a remittance money kind 202 that is a kind of money to be remitted to the store, and a money remittance destination 203 are shown as examples. As a matter of fact, there are no problems even if a plurality of remittance money kinds and a plurality of money remittance destinations can be set. As other information, there may be electronic money information that can be handled at each store.

At a real store A in the example of FIG. 2, the kind of money to be remitted to the store is electronic money A, and an electronic money account A is set as the remittance destination. At a real store B, the kind of money to be remitted to the store is electronic money B, and an electronic money purse in an IC card of a store terminal is set as the remittance destination. At a virtual store A, the kind of money to be remitted to the store is cash A, and a cash account A is set as the transfer destination.

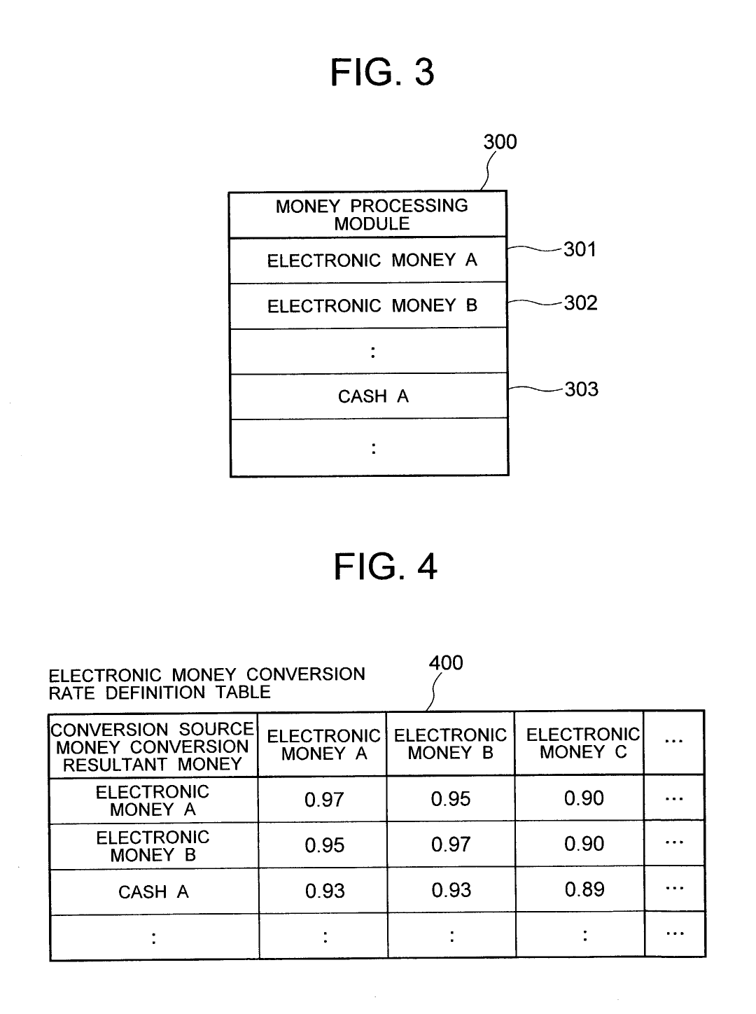

FIG. 3 is a diagram showing an example of a money processing module 300 included in the money individual processing section 102. As for each money, the processing flow of paying-in, payment and movement is individually stipulated in many cases. The processing must be advanced according to a procedure satisfying the stipulation. The above described conversion and remittance of electronic money are conducted in accordance with this processing module. In the example of FIG. 3, modules of electronic money A 301, electronic money B 302 and cash A 303 are shown. If new money has appeared, it becomes possible to handle the new money by adding a corresponding processing module.

FIG. 4 is a diagram showing an example of an electronic money conversion definition table 400 included in the electronic money conversion and remittance section 103. A conversion rate from certain electronic money to other electronic money is found in the electronic money conversion definition table 400. In other words, a conversion rate to be used when converting electronic money paid by a store user to money specified by each store is defined. As a matter of course, the conversion rate can be freely set, and the conversion rate may vary according to the amount of money of conversion. And a difference caused by the conversion becomes earnings of the multi-electronic money settlement-of-account vicarious execution system provider as a fee. Besides, a basic charge of every fixed interval, and an initial expense are considered as earnings.

A concrete example will now be described. For example, it is supposed that a store user conducts payment with electronic money A, the multi-electronic money settlement-of-account vicarious execution system converts the electronic money A to electronic money B, and the store receives the electronic money B. In the electronic money conversion definition table of FIG. 4 at this time, the conversion source money is electronic money A and the conversion destination money is electronic money B. Therefore, the conversion rate becomes 0.95. It is now supposed that the whole fee is imposed on the store. If, for example, the store user pays 1,000 units in electronic money A, 950 units are paid to the store in electronic money B. The difference of 50 units in electronic money becomes earnings of the multi-electronic money settlement-of-account vicarious execution system provider as a fee. On the contrary, if the whole fee is imposed on the store user, then the store user pays 1,052 units (with fractions omitted) of electronic money in electronic money A so that the store may receive 1,000 units of electronic money in electronic money B. The difference of 52 units in electronic money becomes earnings of the multi-electronic money settlement-of-account vicarious execution system in the same way as the foregoing description. As a matter of course, it is also possible to impose the fee on the store and the store user with a fixed ratio.

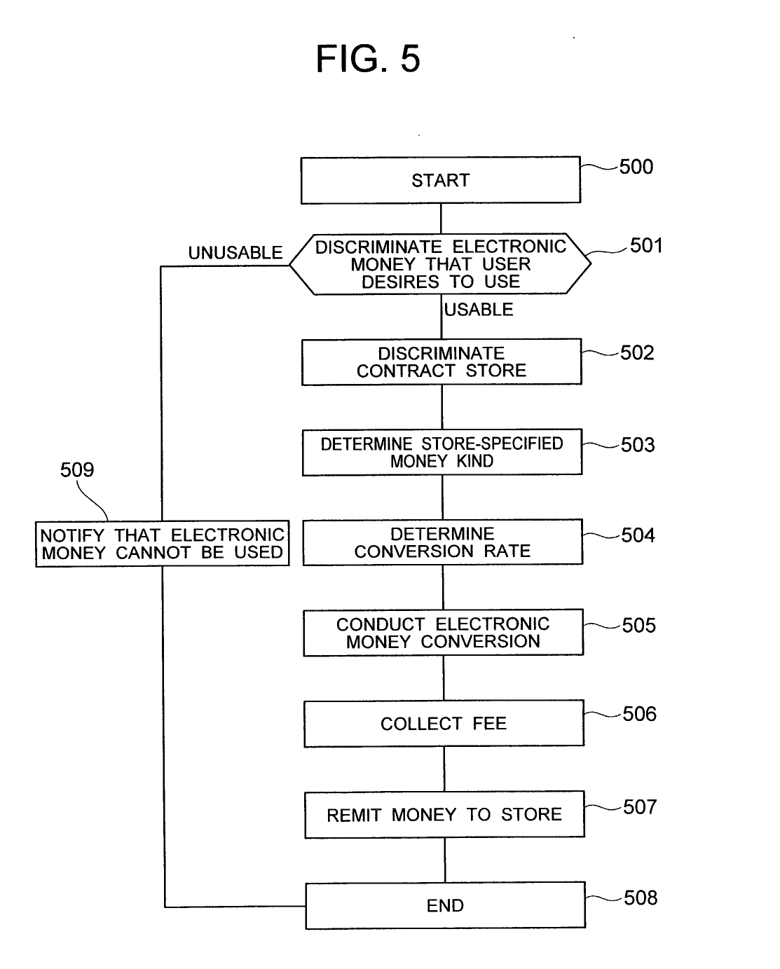

It is now supposed that a certain store user pays a certain kind of electronic money by using a real store terminal or a user terminal, and the multi-electronic money settlement-of-account vicarious execution system converts the electronic money of the certain kind to money of a store-specified money kind specified by the store, and remits the converted money to the store-specified money remittance destination. FIG. 5 is a flow chart showing an example of processing conducted in this case on the multi-electronic money settlement-of-account vicarious execution system side.

A store user starts settlement-of-account processing through a store terminal or a user terminal. In response to this, processing of the multi-electronic money settlement-of-account vicarious execution system is started from step 500. Subsequently at step 501, the kind of electronic money that the user desires to use is discriminated. If the multi-electronic money settlement-of-account vicarious execution system supports that money kind, then the kind of electronic money is stored, and the processing proceeds to step 502. If it is found at the step 501 that the kind of electronic money that the user desires to use is a kind that is not handled by the multi-electronic money settlement-of-account vicarious execution system, then the processing proceeds to step 509, where the user is notified that the electronic money is not handled, and the processing proceeds to step 508 and is finished.

At the step 502, the used store is discriminated on the basis of information such as a store ID that can be obtained through the network. Processing proceeds to step 503. At the step 503, the kind of money to be remitted to the contract store is determined by referring to the store information database 200. The processing proceeds to step 504. At the step 504, the conversion rate between the kind of electronic money used by the user and the kind of money to be remitted to the used store is determined by referring to the electronic money conversion definition table 400. The processing proceeds to step 505. At the step 505, the above described money conversion is conducted. The processing proceeds to step 506. At the step 506, the difference between the amount paid by the store user and the amount of money remitted to the store is collected as a fee. The processing proceeds to step 507. At the step 507, the converted money is remitted to a remittance destination specified by the store by referring to the store information database 200. The processing proceeds to step 508, and the processing is finished.

In the description, the processing conducted at each step is completed at the step. However, the processing is not limited to this, but the following first alternative approach is also possible. First, at the step 500, electronic money is not actually received from the user, but only information of the kind of electronic money that is about to be used and information of the money amount are received. At steps 505 to 507, it is not actually conducted to convert the money, collect the fee, and remit the converted money, but the user is requested to confirm the payment, If the user confirms the payment, then it is actually conducted to receive electronic money, convert the money, collect the fee, and remit the converted money. On the contrary, if the user denies the payment, the processing is not conducted.

In the case where there are a plurality of kinds of electronic money the user desires to use for payment, this first alternative approach makes it possible to compare fees in payments respectively using those kinds of electronic money.

In a second alternative approach, actual money movement is not conducted, but the processing as far as the step 507 is conducted for a plurality of kinds of electronic money, and respective processing results are displayed on the same picture. The user is requested to confirm the payment and select electronic money to be used for payment, if payment is conducted. The second alternative approach facilitates the user's comparison. And when the user has confirmed the payment and selected electronic money, it is actually executed to receive electronic money from the user, convert the money, collect a fee, and remit the converted money to the store-specified money remittance destination.

In a third alternative approach, respective processing results are displayed on the same picture, and the user is requested to confirm the payment and select electronic money to be used for payment, if payment is conducted, in the same way as the second alternative approach. In addition, the user is notified that payment using a combination of a plurality of kinds of electronic money (hereafter also referred to as MIX settlement-of-account) is also possible. If the MIX settlement-of-account has been selected, the user is asked about kinds of electronic money that are about to be combined and used for payment and ratios of those kinds of electronic money in the combination. If the kinds of electronic money and the ratios are given by the user, then the multi-electronic money settlement-of-account vicarious execution system receives a plurality of kinds of electronic money to be used for the payment by amounts according to respective ratios, and converts and remits the respective kinds of electronic money as described above. Thus, the MIX settlement-of-account is completed.

In the third alternative approach, the user can conduct the settlement-of-account by using a plurality of kinds of electronic money, and consequently the convenience is improved. Especially when electronic money of one kind is not enough for the amount to be paid, the amount to be paid can be obtained by combining a plurality of kinds of electronic money. Or when the user wants to use up electronic money of one kind, the user can use up electronic money of the kind by paying the whole amount of electronic money of the kind and paying an amount of shortage in electronic money of another kind.

As a matter of course, it is favorable in such a case to display fees of respective money kinds in a store device so that the user may conduct the payment confirmation and electronic money selection. Therefore, the multi-electronic money settlement-of-account vicarious execution system transmits information of fees of respective money kinds to the store device.

According to the present embodiment, it becomes possible for a user in each contract store to conduct settlement-of-account by using a plurality of kinds of electronic money, as heretofore described. As a matter of course, each contract store need not conclude contracts with respective electronic money service providers, but needs only to conclude a contract with the multi-electronic money settlement-of-account vicarious execution system provider. In addition, introduction of a plurality of devices and a labor for the procedure are not required, resulting in a low cost.

There will now be described an example of the case where service of providing a point according to the kind and amount of conversion of electronic money used by the user to electronic money or cash specified by the store is added to the multi-electronic money settlement-of-account vicarious execution system as heretofore described.

As for the point, for example, points are provided according to the amount of money of a purchased commodity, and the user can be given a discount according to the points when purchasing a commodity the next time or later. This is so-called rewards program. Furthermore, for example, when the user has saved a certain number of points, the points can be exchanged with a prize depending on the points. This is so-called prize exchange service. Furthermore, the points are not limited to them. It is conceivable that a point provider provides a person provided with points with various services in accordance with the number of points.

A multi-electronic money settlement-of-account vicarious execution system with the royalties added can bring about, for example, the following effects. By providing points and giving service according to the number of points, it is possible to urge the user to come to the shop again. Furthermore, by providing a different number of points according to the conversion kind of electronic money, it also becomes possible to impose a suitable fee that differs according to the conversion kind on the user. In other words, the user can receive a large number of points when the user has used electronic money that needs an inexpensive fee for conversion. On the contrary, the user cannot receive so many points when the user has used electronic money that needs an expensive fee for conversion. By doing so, the earning rate of the store (and the burden rate of the store) can be made constant irrespective of the conversion kind of electronic money.

A concrete example will now be described. As for the electronic money conversion rate definition table, the example shown in FIG. 4 is used. For example, it is now supposed that the above described rewards program is given for points, and a discount is conducted by converting one point to one unit of electronic money. And it is supposed that the user purchases a commodity of 1,000 units of electronic money and attempts to pay electronic money A or electronic money C, and the store receives cash A. Furthermore, it is supposed that the store receives substantially 80% (800 units of electronic money in this case) of a selling amount of money and the store pays the fee of the multi-electronic money settlement-of-account vicarious execution system. In this case, the following procedure is conducted.

First, in the case where the user pays electronic money A, the user pays 1,000 units of electronic money in the electronic money A, and it is delivered to the multi-electronic money settlement-of-account vicarious execution system and converted therein by referring to the electronic money conversion rate definition table of FIG. 4. Since the conversion rate is 0.90 in this case, 1,000 units of electronic money in the electronic money A is converted to 900 units of electronic money in cash. And 900 units of electronic money are delivered to the store. Since the store is supposed to receive substantially 800 points of money, the stores provides the user with 100 points corresponding to 100 units of money. Also in the case where the user pays electronic money C, a similar procedure is conducted. That is, the user pays 1,000 units of electronic money in electronic money C. The multi-electronic money settlement-of-account vicarious execution system converts it to 890 unit of money in cash A. The store provides the user with 90 points corresponding to 90 units of money.

The kind of money used for the payment by the user and the kind of money received by the store are not limited to them. Although the example of the rewards program has been described, the same holds true in the case of prize exchange service as well. For example, if saved 500 points can be exchanged with a prize corresponding to 500 points of money, the prize exchange service can be handled in the same way as the above described concrete example by converting one point to 10 units of money. Other services can also be handled in the same way.

By adding royalties to the multi-electronic money settlement-of-account vicarious execution system as heretofore described, the user always needs only to pay the price of the commodity without caring about the conversion fee of the electronic money, and the store can always receive money at a constant earning rate. In addition, the multi-electronic money settlement-of-account vicarious execution system provider can receive a predetermined fee. With respect to a fee that differs depending upon the money conversion kind, points that differ in number according to the fee are provided. Thereby, it is possible to make the sum of the amount obtained by converting points to money and the fee substantially constant.

If points are made usable only at the store on the basis of decision of the store, there is a possibility that the reuse rate of the store will rise. On the contrary, if points are made usable in common in a large number of stores, there is a possibility that it will be helpful in activating the whole of a region store street. Issuance and administration of points may be conducted by the store, or may be conducted by the multi-electronic money settlement-of-account vicarious execution system provider.

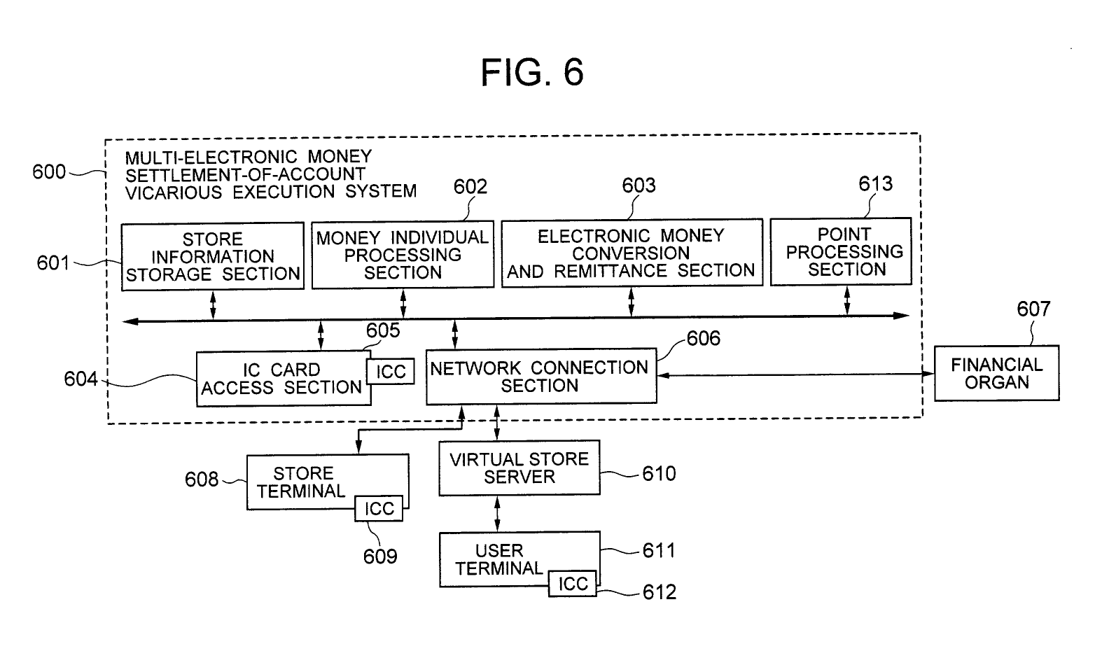

FIG. 6 shows a general configuration example of a multi-electronic money settlement-of-account vicarious execution system with royalties added 600.

In FIG. 6, reference numerals 601 to 612 correspond to the reference numerals 101 to 112 of FIG. 1, and conduct nearly the same operations as the reference numerals 101 to 112 do. Therefore, description of the same operation will be omitted. A principal difference between the multi-electronic money settlement-of-account vicarious execution system with royalties added 600 of FIG. 6 and the multi-electronic money settlement-of-account vicarious execution system 100 of FIG. 1 is in that a point processing section 613 is provided. The point processing section 613 administers points provided for a user in accordance with the kind of conversion between electronic money used by the user and remittance money specified by a store. An ICC 605 can save not only electronic money but also points.

If it is not necessary to handle electronic money and points of intra-ICC storage type and it is not necessary to save points, then the IC card access section 604 and the ICC 605 may be eliminated.

As for the administration of points, there are in general a batch administration scheme and a total amount administration scheme. In the batch administration scheme, the store holds and updates a table that stores point balances of respective users, and conducts batch administration. In the total amount administration scheme, for example, the store previously determines the total amount of points and provides users with points, each user holds points of the user, and the store stores the balance of points as a whole. In other words, the total amount administration scheme is similar to a scheme in which the store creates discount coupons beforehand, and delivers the discount coupons to the user.

In the batch administration scheme in the present embodiment, the point processing section 613 stores information, such as balances of points and terms of validity, of users every user, and conducts batch administration of the information. For example, the point processing section 613 holds a table having the user ID, kind of points, balance of points, day of point provision, and term of validity as items. In addition, it is a matter of course that the ID of the purchased commodity and the store of purchase can also be added. When points are provided in response to a user' purchase of a commodity and when a user uses points, the point processing section 613 suitably updates the information such as the balances of points and the terms of validity of respective users stored within the point processing section 613. Thus, in this case, the point processing section 613 conducts provision or reception of points.

In the total amount administration scheme, information of the kind of points that a user has and the balance of points is stored in an IC card of the user, and the balance of points of the whole is stored in the ICC 605 and administered. As for the information stored in the IC card of each user, information, such as the term of validity, the day of point provision, the commodity ID, and the store of purchase, as described above may be further stored. When points are provided in response to a user' purchase of a commodity and when a user uses points, the point processing section 613 conducts processing of moving points between the IC card of the user and the ICC 605 of the system. Thus, in this case, the point processing section 613 conducts provision or reception of points.

Or the both schemes may be combined. In this case, information, such as the balance of points and the term of validity, of each user is stored in the point processing section and the IC card of the user. The balance of the whole is stored in the ICC 605. The point processing section 613 conducts processing of both schemes. In other words, the point processing section 613 updates the table that stores balances of respective users, and moves provision points from the ICC 605 in the system to the IC card of the user. Thus, the point processing section 613 conducts provision or reception of points.

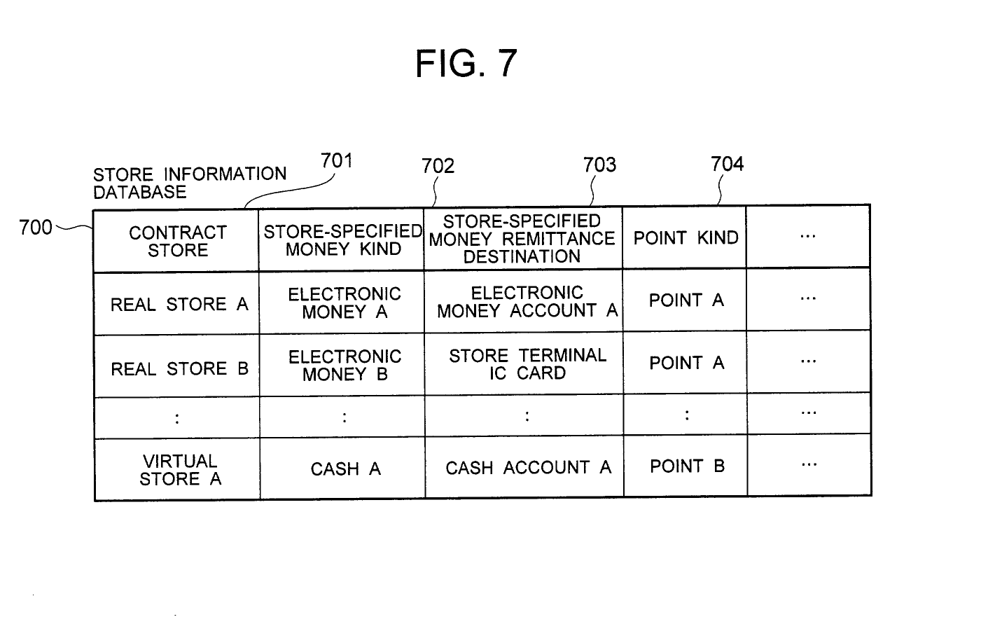

FIG. 7 shows a configuration example of a store information database 700 stored in the store information storage section 601.

In FIG. 7, items 701 to 703 have contents similar to those of the items 201 to 203 of FIG. 2, and description thereof will be omitted. The difference exists in that an item 704 of kind of points to be provided for the user is provided. In the same way as FIG. 2, there are no problems even if a plurality of remittance money kinds, money remittance destinations, and provision point kinds can be set. Furthermore, there are no problems even if electronic money information that can be handled at each store is added as other information.

At a real store A in the example of FIG. 7, the kind of money to be remitted to the store is electronic money A, the remittance destination is an electronic money account A, and a point A is set as the kind of points to be provided for the user. At a real store B, the kind of money to be remitted to the store is electronic money B, the remittance destination is an electronic money purse in an IC card of a store terminal, and a point A is set as the kind of points to be provided for the user. At a virtual store A, the kind of money to be remitted to the store is cash A, the transfer destination is a cash account A, and a point B is set as the kind of points to be provided for the user.

In this example, the point kind can be set from store to store. According to selection on each store side, points common to stores can be provided for the user, or unique points that can be used only at each store can also be provided for the user. Both the real store A and the real store B have the point kind set to the point A in common. Therefore, points provided at the real store A can also be used at the real store B, and points provided at the real store B can also be used at the real store A. On the other hand, at the virtual store A, the point B is set unlike other stores. Therefore, points provided at the virtual store A cannot be used at other stores, and points provided at other stores cannot be used at the virtual store A.

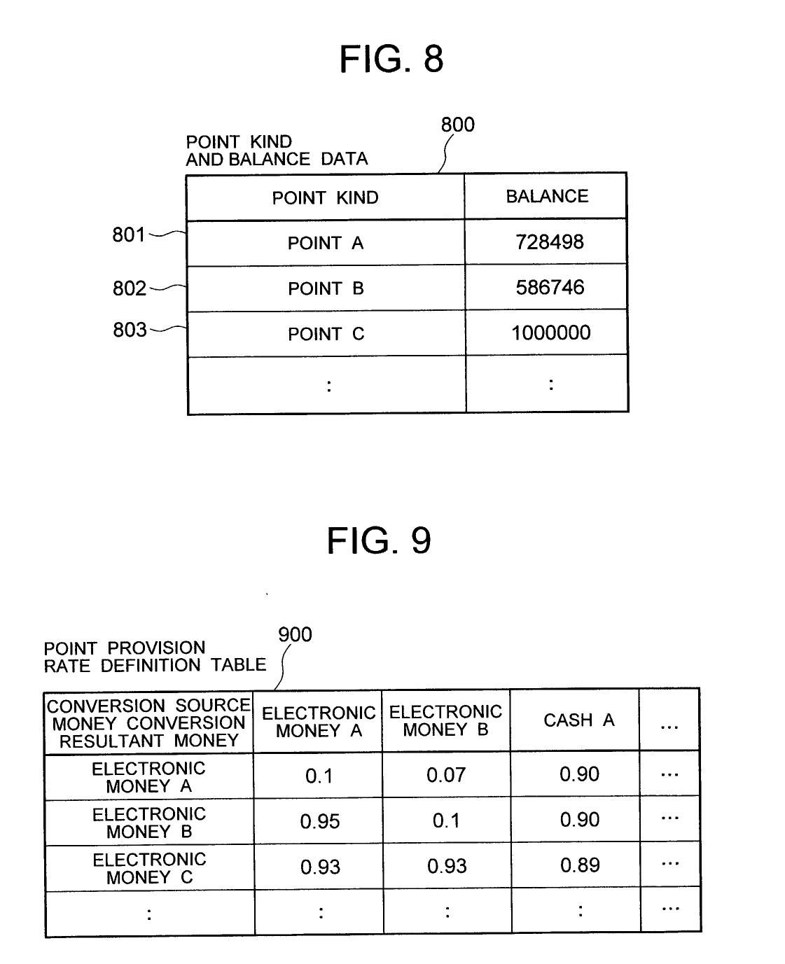

FIG. 8 shows an example of data 800 of the kind and balance of points contained in the point processing section 613. Points are stored in the ICC 605 of the multi-electronic money settlement-of-account vicarious execution system 600. In the example of FIG. 8, the balance of points is 728,498 for a point A 801, 586,746 for a point B 802, and 1,000,000 for a point C 803. It is now assumed that an initial value of each of the point A 801, the point B 802 and the point C 803 is 1,000,000. In the case of the point A 801, therefore, users have 271,502 points at hands at the present time. In the case of the point C 803, points have not been provided for anybody, and the total amount remains in the ICC 605. And in the case of the total amount administration scheme, provision of points for a user is attained as a result of movement of points stored in the ICC 605 to the IC card of the user conducted by the point processing section 613. At this time, information such as the use history and the term of validity of points may be stored in the IC card of the user as occasion demands.

On the other hand, in the case of batch administration scheme, the point processing section 613 stores the table having the user ID of each user, kind of points, balance of points, day of point provision, term of validity, ID of purchased commodity, and purchase store as items, as described above, although not illustrated. Provision or reception of user points is attained as a result of updating the balance of points of the user stored in the ICC 605 conducted by the point processing section 613. In other words, when providing the user with points, the balance of points is updated so as to be increased by the provided points. When the user uses points, the balance of points is updated so as to be decreased by the used points.

FIG. 9 is a diagram showing an example of a point provision rate definition table 900 included in the point processing section 613. The point provision rate definition table 900 indicates a provision rate of points in the case where conversion from certain electronic money to other electronic money is conducted. For example, if the electronic money A, which is the conversion source paid by the store user, has 1,000 units of electronic money, and the kind of money specified for payment to the store is electronic money B, then 70 points are provided for the user. As a matter of course, the provision rate can be freely set, and the provision rate may vary according to the amount of money of conversion. Especially, the point provision rate can be defined so as to make the earning rate of the store (and the burden rate of the store) constant irrespective of the conversion kind of electronic money as described above.

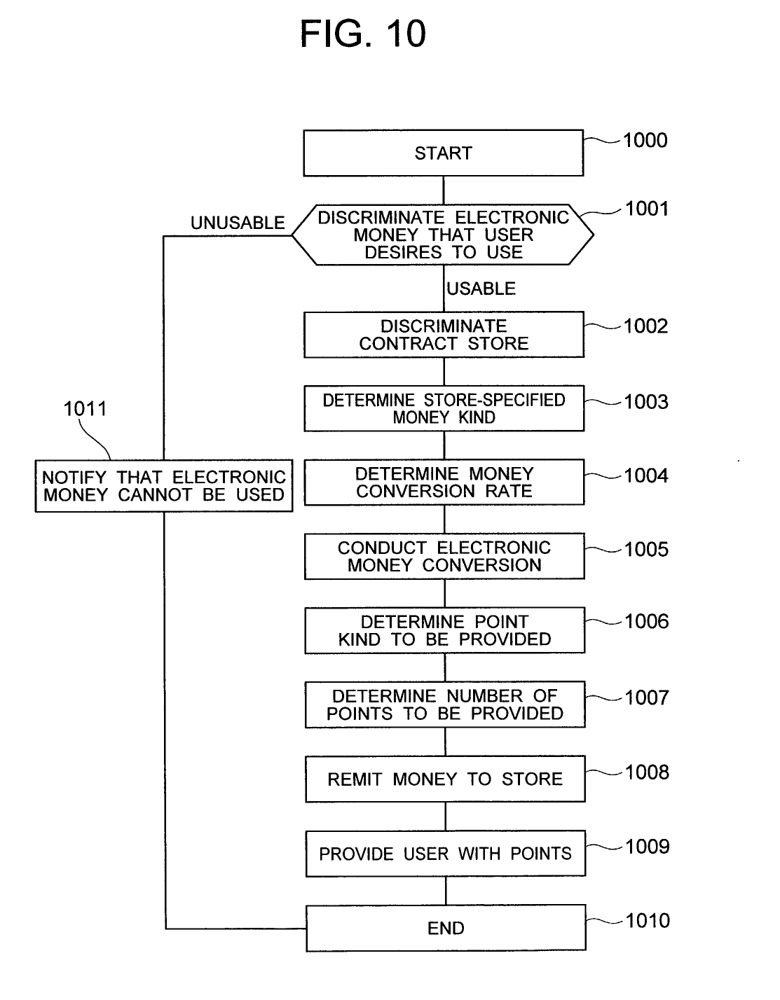

It is now supposed that a certain store user pays a certain kind of electronic money by using a real store terminal or a user terminal, and the multi-electronic money settlement-of-account vicarious execution system converts the electronic money of the certain kind to money of a store-specified money kind, and remits the converted money to the store-specified money remittance destination. In addition, the multi-electronic money settlement-of-account vicarious execution system provides the user with points of a certain kind. FIG. 10 is a flow chart showing an example of processing conducted in this case on the multi-electronic money settlement-of-account vicarious execution system 600 with royalties added.

A store user starts settlement-of-account processing through a store device. In response to this, processing of the multi-electronic money settlement-of-account vicarious execution system is started from step 1000. First, at step 1001, the kind of electronic money that the user desires to use is discriminated. If the multi-electronic money settlement-of-account vicarious execution system supports that money kind, then the kind of electronic money is temporarily stored, and the processing proceeds to step 1002. If it is found at the step 1001 that the kind of electronic money that the user desires to use is a kind that is not handled by the multi-electronic money settlement-of-account vicarious execution system, then the processing proceeds to step 1011, where the user is notified that the electronic money is not handled, and the processing proceeds to step 1010 and is finished.

At the step 1002, the store in use is discriminated on the basis of information such as a store ID that can be obtained through the network. Processing proceeds to step 1003. At the step 1003, the kind of money to be remitted to the store in use is determined by referring to the store information database 700 (FIG. 7). The processing proceeds to step 1004. At the step 1004, the conversion rate between the kind of electronic money used by the user and the store-specified money kind to be remitted to the store in use is determined by referring to the electronic money conversion definition table 400. The processing proceeds to step 1005. At the step 1005, the money conversion is conducted. As described earlier, conversion of electronic money is conducted through a financial organ 607, or by using the ICC in the multi-electronic money settlement-of-account vicarious execution system, or by cooperation between the financial organ 607 and electronic money held in the multi-electronic money settlement-of-account vicarious execution system. After the conversion of electronic money, the processing proceeds to step 1006.

At the step 1006, the point kind specified by the store is determined by referring to the store information database 700 (FIG. 7). The processing proceeds to step 1007. At the step 1007, the number of points to be provided is determined by referring to the point provision rate definition table 900 (FIG. 9) on the basis of conversion from the kind of electronic money used by the user to the kind of money to be remitted to the store in use and the use amount. The processing proceeds to step 1008. At the step 1008, the converted money is remitted to the remittance destination specified by the store. The processing proceeds to step 1009. At the step 1009, points having the point kind determined at the step 1006 and having a number determined at the step 1007 are provided for the user. The processing proceeds to step 1010, and the processing is finished.

In the processing flow of the multi-electronic money settlement-of-account vicarious execution system with royalties added 600 as well, it is possible to advance the processing of respective steps by using only the kind information and money amount information without actual movement of electronic money and finally request the user to confirm payment, in the same way as the foregoing description of the processing flow of the multi-electronic money settlement-of-account vicarious execution system 100 with reference to FIG. 5. And when the user has confirmed payment, money is actually moved and points are provided. Furthermore, in the same way, it is also possible to receive information of a plurality of kinds of electronic money, display respective processing results on the same picture, and request the user to confirm the payment and select electronic money to be used for payment, if payment is conducted. Furthermore, the mixed settlement-of-account may be conducted. When displaying respective processing results on the screen, it is favorable in each of these cases to simultaneously display a fee and/or points in the case where each electronic money is used, in addition to the information of kinds and amounts of money.

Owing to these approaches, not only the above described effects can be obtained, but also it becomes possible to compare points. By watching a fee and/or points of the case where each electronic money is used, the user can determine electronic money or an electronic money combination to be used for payment.

As a matter of course, it is favorable in such a case to display fees and provision points of respective money kinds in a store device so that the money selection. Therefore, the multi-electronic money settlement-of-account vicarious execution system transmits information of fees and provision points of respective money kinds to the store device.

As heretofore described, the multi-electronic money settlement-of-account vicarious execution system with the royalties added 600 brings about an effect of remarkably improving the convenience for the user in conducting settlement-of-account with electronic money. For the store, there is an effect that it is possible to urge users to come to the store again. Furthermore, there is an effect that the earning rate of the store (and the burden rate of the store) can be made constant irrespective of the conversion kind of electronic money, as described above.

Heretofore, there has been described the case where the multi-electronic money settlement-of-account vicarious execution system is used by a user for payment to a store. However, the multi-electronic money settlement-of-account vicarious execution system can also be used not for payment but for exchange. Hereafter, the case where the multi-electronic money settlement-of-account vicarious execution system is used for exchange will be described. However, the case where the multi-electronic money settlement-of-account vicarious execution system is used for exchange is nearly the same in operation as the case where the multi-electronic money settlement-of-account vicarious execution system is used for payment to a store. Therefore, detailed description will be omitted, and different points will now be described. The configuration in this case is the same as that shown in FIG. 1. However, the store information storage section 101 that stores the store information database 200 may be eliminated.

Operation is conducted in the following manner. First, the user inserts the ICC 109 that the user has into the store terminal 108 or conducts radio connection. Or the user inserts the ICC 112 that the user has into the store terminal 111 or conducts radio connection. And the user transmits information concerning electronic money of a certain kind desired to be exchanged and money kinds desired to be received (hereafter also referred to as exchanged kinds) and information concerning remittance destination of money after the exchange to the multi-electronic money settlement-of-account vicarious execution system 100. And the multi-electronic money settlement-of-account vicarious execution system 100 converts the electronic money of the received kind to money of the received exchanged kinds by using a method similar to that in the case of payment. Subsequently, the multi-electronic money settlement-of-account vicarious execution system 100 remits the money obtained by the exchange to a remittance destination on the basis of received information of the remittance destination. In the case where information of a remittance destination is not transmitted to the multi-electronic money settlement-of-account vicarious execution system 100, the money may be remitted to the ICC 109 or 112 of the user. As a result, the exchange is completed. In short, the case of exchange differs from the case of payment in that the money kind after conversion and the remittance destination to be remitted to are determined by referring to the store information database in the case of payment whereas the money kinds after conversion and the remittance destination to be remitted to are received from the user in the case of exchange.

In the case of exchange as well, it is possible to convert electronic money, collect a fee, and provide points by using the electronic money conversion rate definition table 400 (FIG. 4) and the point provision rate definition table 900 (FIG. 9).

Heretofore, the multi-electronic money settlement-of-account vicarious execution system 100 (FIG. 1) and the multi-electronic money settlement-of-account vicarious execution system with royalties 600 (FIG. 6) have been described respectively as dedicated apparatuses. However, this is not restrictive. Alternatively, it is also possible to implement the multi-electronic money settlement-of-account vicarious execution system 100 and the multi-electronic money settlement-of-account vicarious execution system with royalties 600 by using a computer including a network section, a control section, and a storage section. In this case, a program for making the computer execute the above described operation is installed in the computer, and respective sections of the computer function as follows. The network section of the computer functions as the network connection sections 106 and 606. The control section of the computer functions as the electronic money conversion and remittance sections 103 and 603. The storage section of the computer functions as the store information storage sections 101 and 601 and the money individual processing sections 102 and 602. In the case where electronic money of ICC storage type is handled, the computer is equipped with the ICC 105 and 605, and equipped with card readers as the IC card access sections 104 and 604. The program is stored in a storage medium that can be read by a computer, or downloaded through the network.

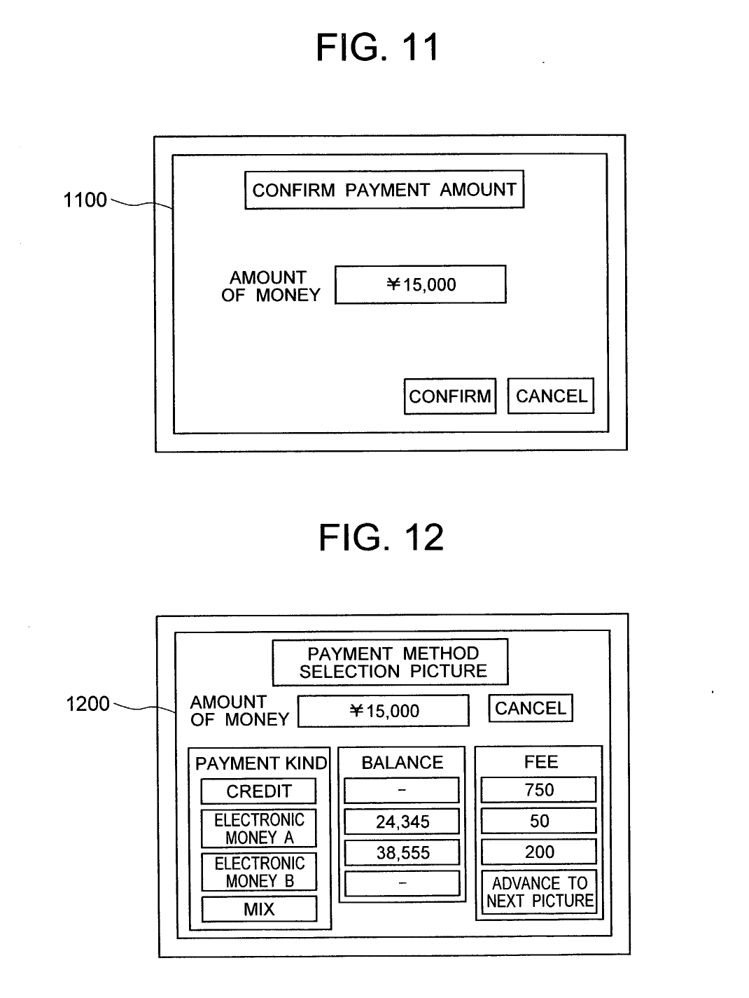

Examples of pictures of a store device will now be described by referring to FIGS. 11 to 16.

FIG. 11 is a diagram showing a picture example 1100 that appears when the user has purchased something at a real store or a virtual store and starts settlement-of-account. The settlement-of-account start picture 1100 is displayed on a display screen of the store device at the step 500 in FIG. 5 or at the step 1000 in FIG. 10. In the settlement-of-account start picture 1100, for example, a purchase amount of money, a “confirm” button and a “cancel” button are displayed. In this example, the user is in a stage of making a purchase of 15,000 yen and confirming an amount to be paid. If the user selects the “confirm,” the picture proceeds to a payment method selection picture (FIGS. 12 to 14). If the user selects the “cancel” button, the settlement-of-account is suspended.

FIG. 12 is a diagram showing a picture example 1200 that appears when the user selects a payment method. The payment method selection picture 1200 is displayed on a display screen of the store device at the step 506 in FIG. 5 or at the step 1007 in FIG. 10 after the user has inserted the IC card that the user has into the store device (in the case of radio connection, after the user has radio-connected the IC card to the store device). As described above, without conducting actual money movement, fee collection, and point provision, processing of the steps 500 to 506 of FIG. 5 or steps 1000 to 1007 of FIG. 10 is conducted. The multi-electronic money settlement-of-account vicarious execution system receives information concerning a plurality of kinds of electronic money from the user, and processes the information. The store device receives and displays resultant information. The payment method selection picture 1200 is displayed at this time.

In the payment method selection picture 1200, for example, a purchase amount of money, one, two or more payment kinds, balance of electronic money when the payment kind is electronic money, fees required in the case where payment is conducted in respective payment kinds, and a “cancel” button are displayed. In the foregoing description, the case where payment is conducted by using electronic money has been described. Besides, payment using a conventional credit card may be conducted. In the payment kinds, MIX which is a payment method of combining a plurality of payment kinds may be included. In this example, the user can select a payment method from among credit, electronic money A, electronic money B and MIX. The store device reads balances of respective electronic money kinds from the IC card that the user has, and displays the balances of respective electronic money kinds on the screen. Furthermore, fees of respective payment kinds received from the multi-electronic money settlement-of-account vicarious execution system are displayed on the screen. The user can determine a payment method with reference to the different fees.

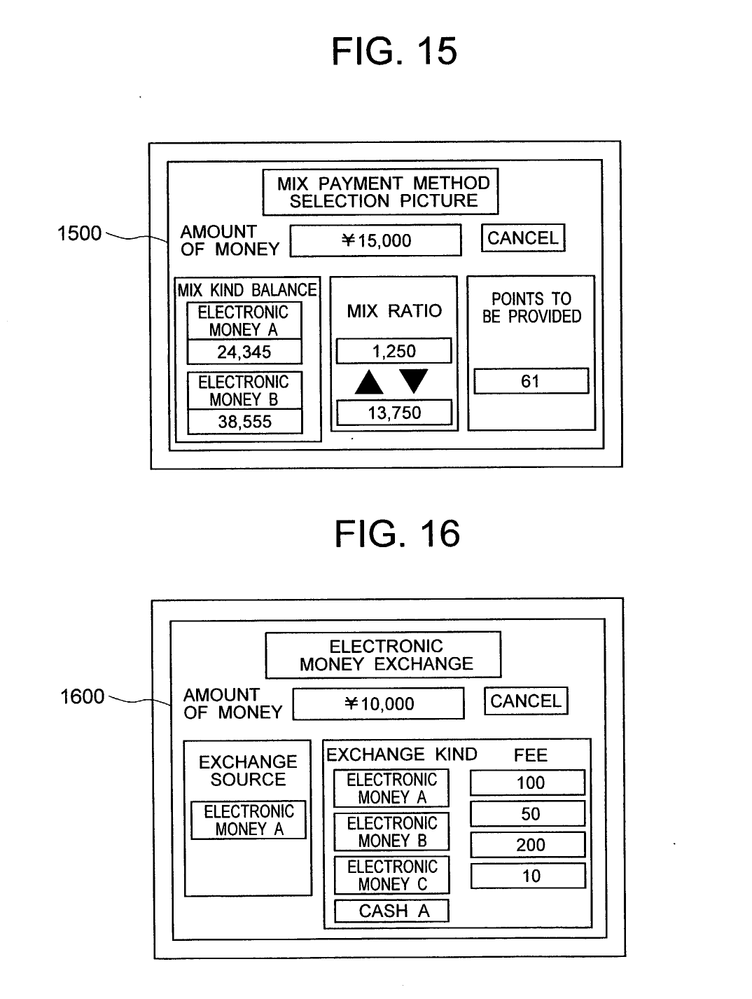

In this example, it is indicated that the fee is the lowest if the electronic money A is used. The difference in fee between the electronic money A and the electronic money B is 150. It is appreciated that the credit has a highest fee, i.e., 750. The MIX is a method of paying a combination of a plurality of electronic money kinds as described above. A picture in the case where MIX is selected will be described later with reference to FIG. 15. By the way, the fee differs depending on the kind of money that the multi-electronic money settlement-of-account vicarious execution system provider finally pays to the store. Furthermore, the payment method selection picture is a picture displayed when the user pays the whole or a part of a conversion fee. In the case where the store pays the whole of the conversion fee, it is not necessary to notify the user of the amount of the fee, and as a matter of course the column of fee becomes unnecessary.

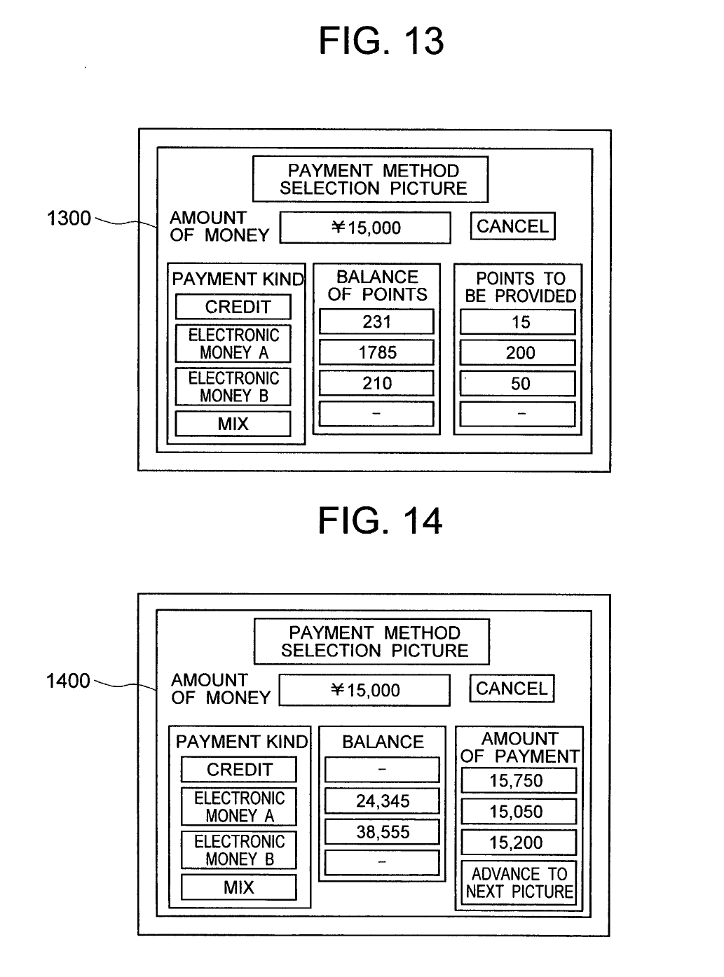

FIG. 13 shows a picture example 1300 for selecting a payment method. In the same way as the payment method selection picture 1200 of FIG. 12, the payment method selection picture 1300 is a picture displayed in the case where the user is requested to first confirm payment and select electronic money before actual movement of money is effected. The payment method selection picture 1300 of FIG. 13 is different from the payment method selection picture 1200 of FIG. 12 in that balances of points and provision points are indicated instead of the balances and fees. The user can select a payment method with reference to the different provision points. Although not illustrated in this example, it is easier to understand if balances of respective kinds of electronic money are simultaneously displayed. Furthermore, an example of the case where the number of points differs according to the payment kind is shown in FIG. 13. However, this is not restrictive. In other words, it is a matter of course that there may be points independent of the payment kinds. Furthermore, as described above, a plurality of points are handled every store or every area in some cases. In this case, points of kinds handled by the store are displayed, and in addition, provision points that differ according to the payment kind are displayed.

FIG. 14 shows a picture example 1400 for selecting a payment method. The payment method selection picture 1400 is nearly the same as the picture example 1200 of FIG. 12. The payment method selection picture 1400 differs from the picture example 1200 in that total amounts of payment are indicated instead of the fees. It is considered that it is sometimes easier for the user to understand if the total amounts of payment are displayed for respective kinds of electronic money used for settlement-of-account. In the same way as FIG. 12, the payment method selection picture is a picture displayed when the user pays the whole or a part of a conversion fee.

FIGS. 12 to 14 have been described as respectively separate pictures. However, it is also possible to combine items displayed in the pictures and display the combined items on one picture. In other words, it is possible to display all or an arbitrary number of items from among the amount of payment, the payment kind, the balance of electronic money, the fee, the total amount of payment, the balance of points, the provision points, the MIX payment, and the cancel button.

FIG. 15 shows a picture example 1500 for selecting a payment method. The payment method selection picture 1500 is a picture displayed when the MIX payment is selected in the examples of FIGS. 12 to 14. In this case, payment can be conducted by combining a plurality of kinds of electronic money. On the picture, balances of a plurality of electronic money kinds to be combined and MIX ratios are displayed. In this picture example, the user has electronic money A and electronic money B, and intends to pay 1,250 units with the electronic money A and 13,750 units with the electronic money B. As a matter of course, combined amounts are arbitrary. The provision points are shown to be 61. However, the provision points should vary according to combined kinds and amounts. As a matter of course, the picture may indicate fees instead of the points, or the total amount of payment, or both of them.

FIG. 16 shows a display picture example 1600 in the case where the user is conducting not the payment at the store but conducting exchange of electronic money directly through the multi-electronic money settlement-of-account vicarious execution system provider. On the exchange picture 1600, for example, the amount of money to be exchanged, exchange source kind, exchange kinds, fees, and a cancel button are displayed. The user has electronic money A as the exchange source, and can exchange it into electronic money kinds B, C, D and E displayed on the picture. In this picture example, the fee differs according to the exchange kind. For example, if the electronic money B is selected, the amount with the fee reduced is remitted to the electronic purse in the IC card of the user. Of course, the amount may be transferred not to the IC card of the user, but to an electronic money account or a cash account. Furthermore, it is also possible to provide points in response to the exchange. In this case, it is desirable to display points instead of or in addition to the fees.

According to the present invention, it becomes possible for each user of a store to simply use electronic money for settlement-of-account at the store without be conscious of the kind of electronic money that the user has and without opening an account in the center, as heretofore described.

While we have shown and described several embodiments in accordance with out invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A multi-electronic money settlement-of-account vicarious execution system comprising:
a network connection section connected to a store device of a store to receive electronic money used by a user of the store for payment from the store device;
a store information storage section for storing information of a store-specified money kind specified by the store as a kind of money to be received by the store and information of a store-specified money remittance destination specified by the store as a remittance destination of money; and
an electronic money conversion and remittance section for converting the electronic money received from the store device to money of the store-specified money kind with reference to the information of the store-specified money kind, and transmitting money resultant from the conversion to the store-specified money remittance destination through said network connection section with reference to information of the store-specified money remittance destination.

2. The multi-electronic money settlement-of-account vicarious execution system according to claim 1, further comprising:
a money individual processing section having a processing module for defining a procedure of paying-in and payment and money movement corresponding to the kind of electronic money received from the store device and each of the store-specified money kinds,
wherein said electronic money conversion and remittance section conducts the conversion and the remittance in accordance with said processing module included in said money individual processing section.

3. The multi-electronic money settlement-of-account vicarious execution system according to claim 1, further comprising:
an IC card for storing electronic money; and
an IC card access section for accessing electronic money stored in the IC card,
wherein said electronic money conversion and remittance section conducts the conversion and the remittance by using the electronic money stored in the IC card.

4. The multi-electronic money settlement-of-account vicarious execution system according to claim 1, wherein
said network connection section is connected to at least one of a financial organ having an account opened by the user to store electronic money to be used for payment by the user, a financial organ having an account opened by said multi-electronic money settlement-of-account vicarious execution system to store electronic money of same kind as the electronic money to be used for payment by the user, a financial organ having an account opened by said multi-electronic money settlement-of-account vicarious execution system to store money of the store-specified money kinds, and a financial organ having an account opened by the store to store money of the store-specified money kinds, and
said electronic money conversion and remittance section transmits a request of paying-in or payment for each of the accounts and/or a request of movement of information of each of the accounts to each of the financial organs when conducting the conversion and the remittance.

5. The multi-electronic money settlement-of-account vicarious execution system according to claim 1, wherein when the information of the store-specified money remittance destination indicates that a money remittance destination specified by the store is an IC card in the store device, said electronic money conversion and remittance section transmits money resultant from the conversion to the IC card.

6. The multi-electronic money settlement-of-account vicarious execution system according to any of claim 4, wherein when the information of the store-specified money remittance destination indicates that a money remittance destination specified by the store is an account of money of the store-specified money kind opened by the store with the financial organ, said electronic money conversion and remittance section transmits money resultant from the conversion to the account.

7. The multi-electronic money settlement-of-account vicarious execution system according to claim 1, wherein
said electronic money conversion and remittance section holds an electronic money conversion rate definition table including definitions of conversion rates respectively determined by combinations of kinds of electronic money received from the user and the store-specified money kinds, and
said electronic money conversion and remittance section conducts the conversion by using said electronic money conversion rate definition table.

8. The multi-electronic money settlement-of-account vicarious execution system according to claim 1, wherein
said store information storage section stores information of point kinds to be provided for the user, and
said multi-electronic money settlement-of-account vicarious execution system further comprises a point processing section for providing the user with points of a kind indicated by the information of the point kinds.

9. The multi-electronic money settlement-of-account vicarious execution system according to claim 8, wherein said point processing section provides the user with points according to a combination of a kind of electronic money received from the user and a kind of money indicated by the information of the store-specified money kind and according to an amount of the electronic money.

10. The multi-electronic money settlement-of-account vicarious execution system according to claim 8, wherein
said point processing section holds a point provision rate definition table including definitions of provision rates respectively determined by combinations of kinds of electronic money received from the user and money kinds indicated by the information of the store-specified money kinds, and
said point processing section provides the user with points determined by using said point provision rate definition table.

11. The multi-electronic money settlement-of-account vicarious execution system according to claim 8, further comprising:
an IC card for storing points; and
an IC card access section for accessing points stored in the IC card,
wherein said point processing section provides the user with points by using the points stored in the IC card.

12. The multi-electronic money settlement-of-account vicarious execution system according to claim 8, wherein
said point processing section holds a point administration table for storing a balance of points that each user has every user, and
said point processing section provides the user with points by updating the balance of points of the user stored in the point administration table.

13. The multi-electronic money settlement-of-account vicarious execution system according to claim 1, wherein
said network connection section receives electronic money of a plurality of kinds from the user per single payment, and
said electronic money conversion and remittance section converts the received electronic money of the plurality of kinds to money of the store-specified money kinds and transmitting all money resultant from the conversion to the store-specified money remittance destinations.

14. An exchange system comprising:
a network connection section connected to a user terminal to receive information concerning electronic money to be exchanged and an exchange kind from a user through the user terminal;
a money individual processing section having a processing module that defines procedures of paying-in, payment, and money movement corresponding to the kind of electronic money received from the user and the exchange kind; and
an electronic money conversion and remittance section for converting electronic money received from the user to money of the exchange kind in accordance with the processing module included in said money individual processing section, and transmitting money resulting from the conversion to the user through said network connection section and the user terminal.

15. A multi-electronic money settlement-of-account vicarious execution method in a computer including a network connection section, a control section, and a storage section, said multi-electronic money settlement-of-account vicarious execution method comprising the steps of:
receiving in the network connection section electronic money used by a store user for payment from a store device of the store;
converting in the control section the electronic money received from the store device to money of a store-specified money kind specified by the store as a kind of money to be received by the store, by referring to information of the store-specified money kind stored in the storage section; and
transmitting, in the control section, money resultant from the conversion to a store-specified money remittance destination specified by the store as a money remittance destination, through said network connection section by referring to information of the store-specified money remittance destination stored in the storage section.

16. The multi-electronic money settlement-of-account vicarious execution method according to claim 15, further comprising the step of providing, in the control section, the user with points of a kind indicated by information of a point kind, by referring to the information of the point kind stored in the storage section.

17. A multi-electronic money settlement-of-account vicarious execution system comprising:
a network connection section for receiving electronic money used by a payer for payment;
a payee information storage section for storing information of a payee-specified money kind specified by a payee as a kind of money to be paid to the payee and information of a payee-specified money remittance destination specified by the payee as a remittance destination of money;
a first IC card for storing electronic money received by said network connection section;
a first IC card access section for accessing said first IC card;
a second IC card for storing electronic money of the payee-specified money kind;
a second IC card access section for accessing said second IC card; and
a control section for controlling said first IC card access section so as to store electronic money received by said network connection section in said first IC card, controlling said second IC card access section so as to read electronic money of the payee-specified money kind from said second IC card by referring to information of the payee-specified money kind, and controlling said network connection section so as to remit electronic money of the read out payee-specified money kind to a remittance destination indicated by information indicated by the information of the payee-specified money remittance destination by referring to the information of the payee-specified money remittance destination.

18. A multi-electronic money settlement-of-account vicarious execution system comprising:
a network connection section connected to a first financial organ having a first account opened by a payer to store electronic money to be used for payment by the payer, a second financial organ having a second account opened by said multi-electronic money settlement-of-account vicarious execution system to store electronic money of same kind as the electronic money to be used for payment by the user, a third financial organ having a third account opened by a payee to store electronic money to be used for reception by the payee, and a fourth financial organ having a fourth account opened by said multi-electronic money settlement-of-account vicarious execution system to store electronic money of same kind as the electronic money to be used by the payee for reception, said network connection section receiving information identifying the account of electronic money to be used by the payer for payment and information indicating a payment amount from the payer; and
a control section for referring to the information identifying the account of electronic money to be used by the payer for payment and information indicating a payment amount received from the payer, generating orders directed to the first to fourth financial organs so as to move the electronic money to be used by the payer for payment, from the first account to the second account by the payment amount, and move the electronic money to be used by the payee for reception, from the fourth account to the third account by the payment amount, and controlling said network connection section so as to transmit the generated orders respectively to the first to fourth financial organs.
